(19) United States
(12) Patent Application Publication
(10) Pub. No.: US 2007/0050534 A1
(43) Pub. Date: Mar. 1, 2007

(54) A METHOD FOR SUPPORTING UNRECOGNIZABLE FLASH MEMORY

(75) Inventors: Lung-Yi Kuo, Tachia Town, Taichung County (TW); Sheng-I Hsu, Yuanlin Town, Changhua County (TW)

Correspondence Address: PAI PATENT & TRADEMARK LAW FIRM, 1001 FOURTH AVENUE, SUITE 3200, SEATTLE, WA, 98154, US

(73) Assignee: SILICONMOTION INC., Jhubei City (TW)

(21) Appl. No.: 11/164,334

(22) Filed: Nov. 18, 2005

(30) Foreign Application Priority Data
Aug. 26, 2005 (TW) 94129364

(51) Int. Cl. G06F 12/00

(52) U.S. Cl. 711/103

(57) ABSTRACT

A method for supporting an unrecognizable flash memory, at least including steps of sending a parameter table comprising strings for error checking to a specified address, checking if the identification is unknown, reading the specified address in the flash memory to determine its cycle if the identification is unknown, checking if the strings for error checking are correctly read, and accessing the system code of the flash memory.

### RELATED APPLICATIONS

The present application is based on, and claims priority from, Taiwan Application Serial Number 94129364, filed Aug. 26, 2005, the disclosure of which is hereby incorporated by reference herein in its entirety.

### BACKGROUND OF THE INVENTION

1. Field of Invention

The invention relates to a method for supporting flash memory and, in particular, to a method for supporting unrecognizable flash memory.

2. Related Art

Since the invention of flash memory in the late 1980s, it has been widely applied. For example, mobile phones, smart phones, personal digital assistants, and digital cameras all use flash memory as their storage memory. As these electronic products require a lot of flash memory, they promote the technological development of flash memory.

Unfortunately, a flash memory with an unrecognizable identification (ID) often causes problems, because all the current flash memory controllers need to know the ID of the flash memory in order to find a corresponding program to operate the memory. Whenever a new kind of flash memory is used, the operating system usually has trouble supporting it. This problem cannot be resolved by the system code because the code is stored in the flash memory. Therefore, it is not operable until the flash ID is recognized.

Currently, there are two solutions. One is to add a serial electrically-erasable programmable read-only memory (serial EEPROM) to support a flash memory with an unknown ID. The other method is to directly modify the internal read-only memory (ROM) code to support the flash memory. Regardless, either method increases cost and wastes time.

It is therefore imperative to provide a method for supporting an unrecognizable flash memory.

### SUMMARY OF THE INVENTION

In view of the foregoing, it is an objective of the invention to provide a method for supporting an unrecognizable flash memory in order to support the flash memory with an unknown ID.

A preferred embodiment of the invention includes at least the steps of: sending a parameter table comprising strings for error checking to a specified address (device 0/block 0/page 0), checking if an identification is unknown, reading the specified address (device 0/block 0/page 0) in the flash memory to determine its cycle if the identification is unknown, checking if the strings for error checking are correctly read, and accessing the system code of the flash memory. Recognizing a flash memory with an unknown ID using this method enables one to obtain immediate support without increasing cost.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 shows the system structure of the invention; and

FIG. 2 is a flowchart of the invention.

### DETAILED DESCRIPTION OF THE INVENTION

The present invention will be apparent from the following detailed description, which proceeds with reference to the accompanying drawings, wherein the same references relate to the same elements.

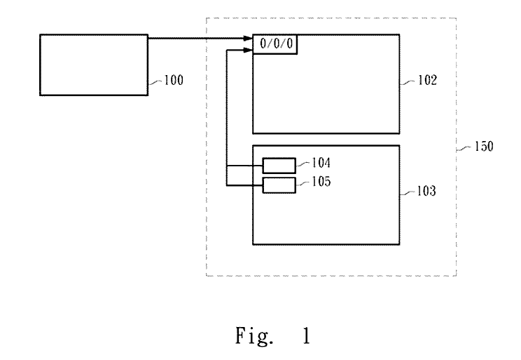

FIG. 1 shows the system structure of the invention. The flash memory chip 150 includes flash memory 102 and flash memory controller 103. The flash memory controller 103 has firmware with two different functions. The first firmware is read-only memory (ROM) 105 with an identification list (ID List) for determining different types of flash memory. The second firmware is ROM 104 for checking the type of the flash memory with an unknown ID. In short, the ROM 105 is used to process flash memory with a known ID, and the ROM 104 is used to process flash memory with an unknown ID.

When checking the type of the flash memory 102, the computer 100 first sends a parameter table to a specified address (device 0/block 0/page 0) to the flash memory 102. The parameter table includes commands, addresses, and data. The parameter table is then used to check the ID of the flash memory 102. If the ID of the flash memory 102 can be identified as one in the ID list of the ROM 105, then it is not an unknown ID and the ROM 105 determines the type of the flash memory 102. If the ID of the flash 102 is different from any one in the ID list of the flash memory 105, then it is an unknown ID and the ROM 104 directly checks the address (device 0/block 0/page 0) of the flash memory 102. Since the commands in the parameter table of the flash memory 102 are roughly the same, the type of the flash memory 102 can be determined by reading the address cycle of the parameter table in the flash memory 102.

For example, suppose there is a flash memory 102 with an unknown ID and an address cycle of 3. First, the computer 100 sends a parameter table to a specified address (device 0/block 0/page 0) of the flash memory 102. The ID of the flash memory 102 is checked. Since the ID of the flash memory 102 is different from any one in the ID list of the ROM of the flash memory controller 103, the ID of the flash memory 102 is thus determined to be an unknown ID. Therefore, the ROM 104 directly tests the specified address (device 0/block 0/page 0) of the flash memory 102 and determines that the address cycle of the parameter table of the flash memory 102 is 3, thereby determining the type of the flash memory 102.

To confirm the correctness of the operation, the parameter table includes strings for error checking. They are used for checking sums or cyclic redundancy checks (CRC) to avoid erroneous determinations.

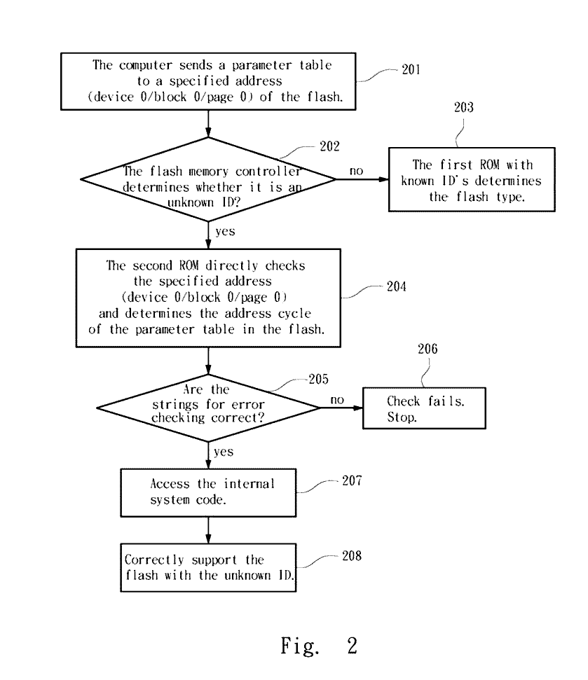

Reference is made simultaneously to FIGS. 1 and 2. FIG. 2 is a flowchart of the method for supporting the unknown ID of the flash memory 102. In step 201, the computer sends a parameter to a specified address (device 0/block 0/page 0) of the flash memory 102. In step 202, the ID of the flash memory 102 is checked. If the ID can be identified with one in the ID list of the ROM 105 of the flash memory controller 103, then it is not an unknown ID. In this case, the ROM 105 is used to determine the type of the flash memory 102 following a normal means in step 203. If the ID of the flash memory 102 is determined as an unknown ID in step 202, then step 204 is performed. The ROM 104 directly checks the specified address (device 0/block 0/page 0) and determines whether the address cycle of the parameter table in the flash memory is 3, 4, or 5. Once the type of the address cycle is correctly read, step 205 is performed. Step 205 checks if the string for error checking is correct. If not, then step 206 is performed to claim a checking failure. If the strings for error checking are correct, then step 207 is performed to access the internal system code stored in the flash memory according to the type of the address cycle. Finally, the flash memory with the unknown ID can be properly supported in step 208.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for recognizing the identification (ID) of flash memory, comprising the steps of:
sending a parameter table to a specified address of a flash memory;
checking an ID of the flash memory;
determining the type of the flash memory if the ID of the flash memory is not unknown; and
checking the specified address to determine an address cycle of the parameter table of the flash memory, then accessing the internal system code of the flash memory according to the address cycle if the ID of the flash memory is unknown.

2. The method of claim 1, wherein the specified address is device 0/block 0/page 0.

3. The method of claim 1, wherein the address cycle is 3, 4, or 5.

4. The method of claim 1, wherein the parameter table further includes a string for error checking to avoid erroneous determinations.

5. The method of claim 4, wherein the string for error checking is a check sum.

6. The method of claim 4, wherein the string for error checking is a cyclic redundancy check (CRC).

7. The method of claim 4 further comprising the step of claiming a check failure when the string for error checking is not correctly read.

8. A device for determining the ID of flash memory, comprising:
a computer, which is coupled to a flash memory to be determined, and is used to send a parameter table to a specified address in the flash memory; and
a flash memory controller, which is coupled to the flash memory to determine whether the ID of the flash memory is an unknown ID, and which comprises:
a first firmware, which has an ID list to compare with the ID of the flash memory; and
a second firmware, which is used to check the specified address of the flash memory when the ID of the flash memory is different from every ID in the ID list, to read an address cycle of the parameter table of the flash memory, and to access the internal system code of the flash memory according to the address cycle.

9. The device of claim 8, wherein the specified address is device 0/block 0/page 0.

10. The device of claim 8, wherein the address cycle is 3, 4, or 5.

11. The device of claim 8, wherein the parameter table further includes a string for error checking to avoid erroneous determinations.

12. The device of claim 11, wherein the string for error checking is a check sum.

13. The device of claim 11, wherein the string for error checking is a cyclic redundancy check (CRC).

14. The device of claim 8, wherein the second firmware is read-only memory (ROM).
